(19) United States
(12) Patent Application Publication
(10) Pub. No.: US 2013/0111249 A1
(43) Pub. Date: May 2, 2013

(54) ACCESSING A LOCAL STORAGE DEVICE USING AN AUXILIARY PROCESSOR

(71) Applicants: Jichuan Chang, Sunnyvale, CA (US); Parthasarathy Ranganathan, San Jose, CA (US); Mehul A. Shah, Saratoga, CA (US)

(72) Inventors: Jichuan Chang, Sunnyvale, CA (US); Parthasarathy Ranganathan, San Jose, CA (US); Mehul A. Shah, Saratoga, CA (US)

(21) Appl. No.: 13/810,187

(22) PCT Filed: Jul. 21, 2010
(86) PCT No.: PCT/US10/42761

§ 371 Date: Jan. 14, 2013

(51) Int. Cl. G06F 1/32

(52) U.S. Cl. CPC G06F 1/3293
USPC 713/324

(57) ABSTRACT

The present disclosure includes accessing a local storage device using an auxiliary processor An example computing device (100, 202, 303) includes a local storage device (110, 210, 310), a first processor (112, 212, 312) able to access the local storage device (110, 210, 310), an auxiliary processor (114, 220, 360) able to access the local storage device (110, 210, 310) while the first processor (112, 212, 312) is shut down, wherein the auxiliary processor (114, 220, 360) uses less power than the first processor (112, 212, 312), and a management agent (125, 225, 370) to initiate an accessing of the local storage device (110, 210, 310) by the auxiliary processor (114, 220, 360) if a load associated with the computing device (100, 202, 303) falls below a particular threshold. One of the first processor (112, 212, 312) and the auxiliary processor (114, 220, 360) is able to access the local storage device (110, 210, 310) at a time.

### BACKGROUND

A computing device, such as a server, may include a processor. The processor can execute the instructions of computer programs stored in a memory of the computing device. For example, the processor can execute the instructions of computer programs and access data stored in a local storage device of the computing device, such as a hard disk drive on the server.

During operation of a computing device, the load of the computing device may vary over time. For example, the load of a computing device is greater during peak usage times than during non-peak usage times. As the load of a computing device changes, the utilization of a processor in the computing device, e.g., the percentage of the processor's total capacity that is being used, also changes. That is, if the load of the computing device increases, the utilization of the processor also increases, and if the load of the computing device decreases, the utilization of the processor also decreases. For example, the utilization of a processor at a peak usage time may be approximately 100%, and the utilization of a processor at a non-peak usage time may be approximately 10%.

Although the load of a computing device and/or the utilization of a processor in the computing device may vary during operation of the computing device, the amount of power used by the processor does not necessarily change proportionally with the change in load and/or utilization. That is, a portion of the amount of power used by the processor may be independent of the load of the computing device and/or the utilization of the processor. For example, the processor may use at least a particular amount of power regardless of the load of the computing device and/or the utilization of the processor,

Because the amount of power used by a processor does not necessarily change proportionally with a change in utilization of the processor, a low utilization of the processor may be an inefficient use of power. That is, power may be wasted while the utilization of the processor is low. In contrast, a high utilization of the processor uses power more efficiently.

### BRIEF DESCRIPTION OF THE DRAWINGS

FIG. 1 illustrates a block diagram of a computing device in accordance with an example of the present disclosure.

FIG. 2 illustrates a block diagram of a computing device in accordance with an example of the present disclosure.

FIG. 3 illustrates a block diagram of a computing device in accordance with an example of the present disclosure.

### DETAILED DESCRIPTION

The present disclosure includes accessing a local storage device using an auxiliary processor. An example computing device includes a local storage device, a first processor able to access the local storage device, an auxiliary processor able to access the local storage device while the first processor is shut down, wherein the auxiliary processor uses less power than the first processor, and a management agent to initiate an accessing of the local storage device by the auxiliary processor if a load associated with the computing device falls below a particular threshold. One of the first processor and the auxiliary processor is able to access the local storage device at a time.

Computing devices in accordance with the present disclosure may use power more efficiently than previous computing devices, e.g., computing devices that include a single processor. That is, computing devices in accordance with the present disclosure may use less power than previous computing devices, often with lower computing capabilities (e.g., lower performance under high demand loads). For example, the auxiliary processor may use less power than the first processor. In situations in which utilization of the first processor may be low, e.g., in situations in which power use by the first processor may be inefficient, the computing device, e.g., the management agent, may shut down the first processor and use the auxiliary processor instead of the first processor, thereby increasing power use efficiency, e.g., using less power.

Computing devices in accordance with the present disclosure may include a second, e.g., auxiliary, processor that can access a local storage device in the computing device, such as a hard disk drive, while the first, e.g., main, processor is shut down. Because the second processor can access the local storage device while the first processor is shut down, the second processor can be used to access data stored in the local storage device and/or execute the instructions of computer programs stored in the local storage device while the first processor is shut down. In contrast, previous computing devices may include a second processor that is unable to access a local storage device in the previous computing device when the first processor is shut down. Because the second processor of the previous computing device may not be able to access the local storage device while the first processor is shut down, the second processor may not be used to access data stored in the local storage device and/or execute the instructions of computer programs stored in the local storage device while the first processor of the previous computing device is shut down. Accordingly, the first processor of the previous computing device may not be shut down, e.g., the first processor of the previous computing device may need to remain powered up.

In the following detailed description of the present disclosure, reference is made to the accompanying drawings that form a part hereof, and in which is shown by way of illustration how a number of examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure.

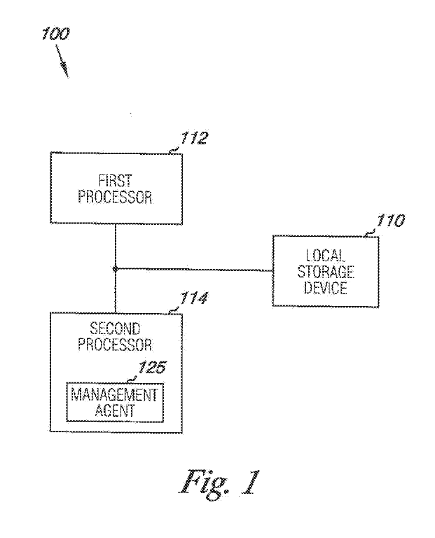

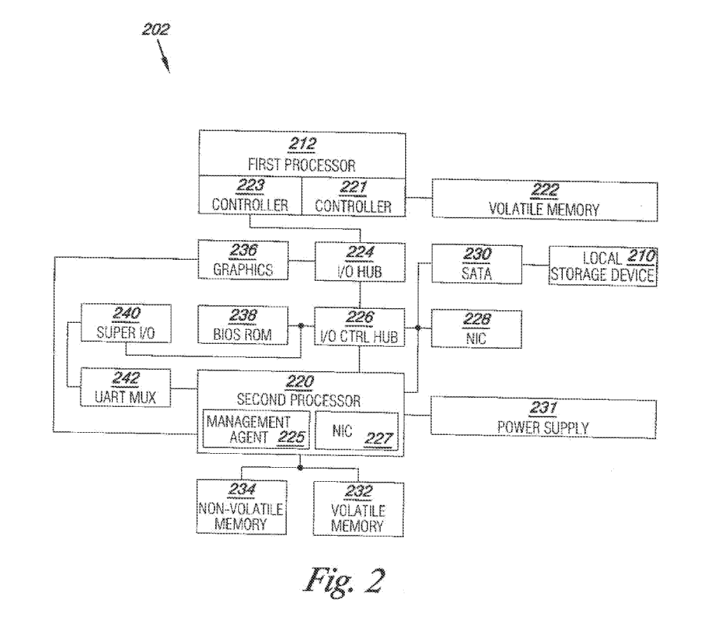

The figures herein follow a numbering convention in which the first digit or digits correspond to the drawing figure number and the remaining digits identify an element or component in the drawing. Similar elements or components between different figures may be identified by the use of si digits. For example, 110 may reference element “10” in FIG. 1, and a similar element may be referenced as 210 in FIG. 2.

As will be appreciated, elements shown in the various examples herein can be added, exchanged, and/or eliminated so as to provide a number of additional examples of the present disclosure. In addition, as will be appreciated, the proportion and the relative scale of the elements provided in the figures are intended to illustrate the examples of the present disclosure, and should not be taken in a limiting sense.

FIG. 1 illustrates a block diagram of a computing device 100 in accordance with an example of the present disclosure. Computing device 100 can be, for example, a server, e,g., a computing device capable of connecting to another computing device to send and/or receive information, including web requests for information from the computing device, and the like. However, the present disclosure is not limited to a particular type of computing device.

As shown in FIG. 1, computing device 100 includes a local storage device 110. Local storage device 110 can be a data and/or program storage component, e.g., a memory, that is local to computing device 100. For example, local storage device. 110 can be a hard disk drive (HDD) of a server. However, the present disclosure is not limited to a particular type of local storage device.

Computing device 100 also includes first processor 112 coupled to local storage device 110, as illustrated in FIG. 1. First processor 112 can be the main, e.g., primary, processor of computing device 100. For example, first processor 112 can use more power, have a greater capability, be faster, and/or have more on-board memory than any other processor in computing device 100. For instance, first processor 112 can be a central processing unit (CPU) of a server,

Computing device 100 also includes second processor 114 separate, e.g., physically and/or operationally separate, from first processor 112 and coupled to local storage device 110, as shown in FIG. 1. Second processor 114 can be an auxiliary processor, e.g., an additional processor at supplements first processor 112. For example, second processor can use less power, have less capability, be slower, and/or have less on-board memory than first processor 112. For instance, second processor 114 can have smaller and/or fewer caches, such as a smaller level-2 (L2) cache, among other types of caches, than first processor 112. Additionally, second processor 114 can have smaller and/or fewer buffers, such as smaller and/or fewer file buffers and/or a smaller and/or fewer operating system buffers, among other types of buffers, than first processor 112. Further, second processor 114 can be used for data intensive tasks, such as spam filtering, index uploading, email servicing, and/or video servicing, among others.

First processor 112 can access local storage device 110. For example, first processor 112 can access data stored in local storage device 110 and/or execute the instructions of programs stored in local storage device 110. Second, e.g., auxiliary, processor 114 can access local storage device 110 while first processor 112 is shut down, e.g., while no power is power is provided to first processor 112, while first processor 112 is in an idle state, and/or while first processor 112 is in a sleep state. For example, second processor 114 can access data stored in local storage device 110 and/or execute the instructions of programs stored in local storage device 110 while first processor 112 is shut down. First processor 112 can be shut down at a particular time of day and/or if a load associated with computing device 100 falls below a particular threshold, e.g., in situations in which utilization of first processor 112 may be low, as will be further described herein.

As shown in FIG. 1, computing device 100, e.g., second processor 114, includes a management agent 125. Management agent 125 can be a software or hardware agent that monitors and/or manages the operation of computing device 100. For example, management agent 125 can initiate an accessing of local storage device 110 by second processor 114 if a load associated with computing device 100 falls below a particular threshold, as will be further described herein,

Although management agent 125 is illustrated in FIG. 1 as being included in second processor 114, the present disclosure is not limited to such a location for management agent 125. For example, management agent 125 can also be separate, e.g., physically and/or operationally separate, from second processor 114, as will be further described herein.

One of first processor 112 and second processor 114 can access local storage device 110 at a time. That is, first processor 112 and second processor 114 may not access local storage device concurrently, e.g., second processor 114 may not access local storage device 110 while first processor 112 accesses local storage device 110, and first processor 112 may not access local storage device 110 while second processor 114 accesses local storage device 110.

First processor 11 can access local storage device 110 using an operating system, and second processor 114 can access local storage device 110 using the operating system. That is, the same operating system can be used by first processor 112 and second processor 114 to access local storage device 110.

Additionally and/or alternatively, first processor 112 can access local storage device 110 using a first operating system, and second processor 114 can access local storage device 110 using a second operating system that is different than the first operating system. That is, different operating systems can be used by first processor 112 and second processor 114 to access local storage device 110. For example, second processor 114 can access local storage device 110 using a dedicated virtual machine appliance.

Second processor 114 can use less power than first processor 112. That is, first processor 112 can use a first amount of power, and second processor 114 can use a second amount of power that is less than the first amount of power. Because second processor 114 can use less power than first processor 112, computing device 100 can use less power than previous computing devices, e.g., computing devices that include a single processor such as a single main CPU, while first processor 112 is shut down and second processor 114 is operating. That is, computing device 100 can use power more efficiently than previous computing devices.

FIG. 2 illustrates a block diagram of a computing device 202 in accordance with an example of the present disclosure. Computing device 202 can be, for example, a server, among other types of computing devices.

As shown in FIG. 2, computing device 202 includes a local storage device 210. Local storage device 210 can be analogous to local storage device 110 previously described in connection with FIG. 1.

Computing device 202 also includes a first processor 212, as illustrated in FIG. 2. First processor 212 can be the main processor of computing device 202, in a manner analogous to first processor 112 previously described in connection with FIG. 1. Additionally, first processor 212 can include controllers 221 and 223, as illustrated in FIG. 2. Controller 221 can be, for example, a memory controller, and controller 223 can be, for example, a quick path interconnect (QPI) controller.

Computing device 202 also includes a second processor 220, as shown in FIG. 2. Second processor 220 can be an auxiliary processor, in a manner analogous to second processor 114 previously described in connection with FIG. 1. Additionally, second, e.g., auxiliary, processor 220 can include a management agent 225, as illustrated in FIG. 2. Second processor 220 can be coupled to a power supply 231, as shown in FIG. 2. Second processor 220 can be coupled to power supply 231 by, for example, an inter-integrated circuit (120).

Second processor 220 can also optionally include a component, e.g., network interface controller (NIC) 227, to access a network, as illustrated in FIG. 2. In examples of the present disclosure in which second processor 220 includes NIC 227, second processor 220 can use NIC 227 to access a network, such as a storage area network as will be further described herein.

As shown in FIG. 2, computing device 202 also includes an input/output (I/O) hub 224 coupled to first processor 212, e.g., to controller 223 of first processor 212. I/O hub 224 can be coupled to first processor by, for example, a quick path interconnect (QPI) connection. Computing device 202 also includes an I/O controller hub 226 coupled to I/O hub 224, as illustrated in FIG. 2. I/O hub 224 and I/O controller hub 226 can be coupled by, for example, a direct media interface (DMI) connection. As shown in FIG. 2, 110 controller hub 226 is also coupled to second processor 220. I/O controller hub 226 can be coupled to second processor 220 by, for example, a universal serial bus (USB) connection.

As illustrated in FIG. 2, computing device 202 also includes a network interface controller (NIC) 228 and a serial advanced technology attachment (SATA) 230 coupled to second processor 220 and I/O controller hub 226. NIC 228 and SATA 230 can be coupled to second processor 220 and I/O controller hub 226 by, for example, a peripheral component interconnect (PCI). Local storage device 210 is coupled to SATA 230, as shown in FIG. 2.

Computing device 202 also includes a volatile memory 232 and a nonvolatile memory 234 coupled to second processor 220, as illustrated in FIG. 2. Volatile memory 232 can be a memory that depends upon power to store information, such as various types of dynamic random access memory (DRAM), among others. Non-volatile memory 234 can be a memory that does not depend upon power to store information. Examples of non-volatile memory can include solid state media such as flash memory, EEPROM, phase change random access memory (PCRAM), among others.

Volatile memory 232 and/or non-volatile memory 234 can be non-transitory computer readable media having computer readable instructions, e.g., computer program instructions, stored thereon that are executable by a processor, e.g., second processor 220, to perform various examples of the present disclosure. However, the present disclosure is not limited to a particular type of memory. That is, the present disclosure can include any type of non-transitory computer readable medium, such as internal memory, portable memory, portable disks, memory located internal to another computing resource (e.g., enabling the computer-readable instructions to be downloaded over the Internet), optical discs, digital video discs (DVD), high definition digital versatile discs (HD DVD), compact discs (CD), laser discs, and magnetic media such as tape drives and floppy discs, among other types of non-transitory computer readable media, having computer readable instructions stored thereon that are executable by a processor to perform various examples of the present disclosure.

First processor 212 can access local storage device 210, in a manner analogous to first processor 112 previously described in connection with FIG. 1. Further, one of first processor 212 and second processor 220 can access local storage device 210 at a time, in a manner analogous to first processor 112 and second processor 114 previously described in connection with FIG. 1.

If a load associated with computing device 02 falls below a particular threshold, management agent 225 can shut down, e.g., initiate a power-down of and/or initiate a sleep state in, first processor 212 The load associated with computing device 202 can be the amount of work being done by computing device 202. For example, the load associated with computing device 202 can be a utilization of first processor 212, e.g., the percentage of the total capacity of first processor 212 that is being used. That is, if the utilization of first processor 212 falls below a particular threshold, management agent 225 can shut down first processor 212.

Management agent 225 can also shut down first processor 212 at a particular time of day. For example, management agent 225 can shut down first processor 212 during non-peak usage times, e.g., during the night when usage of computing device 202 may be low.

While first processor 212 is shut down, e.g., upon and/or after the shut down of first processor 212, second processor 220 can access local storage device 210. In a manner analogous to second processor 114 previously described in connection with FIG. 1. For example, second processor 220 can access local storage device 210 using the same operating system as and/or a different operating system than first processor 212. The accessing of local storage device 210 by second processor 220 can be initiated by management agent 225. For example, if first processor 212 is shut down, management agent. 225 can initiate a power-up of second processor 220, and then initiate the accessing of local storage device 210 by second processor 220.

Second processor 220 can use less power than first processor 212 while accessing local storage device 210. Hence, computing device 202 can use less power than if first processor 212 was left running to access local storage device 210, in a manner analogous to computing device 100 previously described in connection with FIG. 1.

If the load associated with computing device 202 exceeds a particular threshold while second processor 220 is accessing local storage device 210, management agent 225 can shut down second processor 220. The load associated with computing device 202 can be, for example, a utilization of second processor 220, e.g., a percentage of the capacity of second processor 220 that is being used. That is, if the utilization of second processor 220 exceeds a particular threshold, management agent 225 can shut down second processor 220.

Management agent 225 can also shut down second processor 220 at a particular time of day. For example, management agent 225 can shut down second processor 220 during peak usage times, e.g., during the day, when usage of computing device 202 may by high.

Upon shutting down second processor 220, management agent 225 can restart, e.g., initiate a power-up of, first processor 212, and then resume the accessing of local storage device 210 by first processor 212. That is first processor 212 can access local storage device 210 after the shut down of second processor 220.

In examples of the present disclosure in which second processor 220 includes NIC 227, second processor 220 can be an agent node in a distributed storage system. A distributed storage system can include a number of computing devices, e.g., servers, having data and/or program instructions stored thereon. The servers can be connected through, a network, such as a storage area network. The distributed storage system can be partitioned, e.g., divided, between servers that handle compute intensive tasks, such as program execution, and servers that handle data, e.g., storage, intensive tasks, such as spam filtering, index uploading, email servicing, and/or video servicing. The servers that handle compute intensive tasks can have active, e.g., powered-up, main processors, and the servers that handle data intensive tasks can have active auxiliary processors. That is, the active processors of the servers that handle compute intensive tasks can be analogous to first processor 212, and the active processors of the servers that handle data intensive tasks can be analogous to second processor 220.

As the amount and/or percentage of compute intensive and/or data intensive tasks performed by the distributed storage system changes during operation of the distributed storage system, management agent 225 can change the number of servers in the system having active main processors and/or the number of servers in the system having active auxiliary processors. For example, if the number of compute intensive tasks performed by the system decreases and the number of data intensive tasks performed by the system increases, management agent 225 can decrease the number of servers having active main processors and increase the number of servers having active auxiliary processors. That is, management agent 225 can shut down a number of the active main processors and power up a number of auxiliary processors.

As shown in FIG. 2, computing device 202 includes a volatile memory 222 coupled to first processor 212, e.g., to controller 221 of first processor 212. Volatile memory 222 can be coupled to first processor 212 by, for example, a double data rate (DDR) connection. Volatile memory 222 can be, for example, a DRAM. However, the present disclosure is not limited to a particular type of volatile memory.

Data stored in volatile memory 222 can be transferred, flushed, to local storage device 210 prior to shutting down first processor 212. For example, volatile memory 222 can include metadata associated with the operating system used to access local storage device 210. This metadata can be transferred to local storage device 210 prior to shutting down first processor 212. Second processor 220 can then use this metadata to access local storage device 210.

Computing device 202 also includes a graphics module 236 coupled to second processor 220 and I/O hub 224, as illustrated in FIG. 2. Graphics module 236 can be coupled to second processor 220 by, for example, a digital video connection, and graphics module 236 can be coupled to I/O hub 224 by, for example, a peripheral component interconnect express (PCIe) connection.

As shown in FIG. 2, computing device 202 also includes a basic input/output system read only memory (BIOS ROM) 238 and a super I/O 240 coupled to I/O control hub 226. BIOS ROM 238 and super I/O 240 can be coupled to I/O control hub 226 by, for example a low pin count (LPC) bus connection. Computing device 202 also includes a universal asynchronous receiver/transmitter multiplexer (CART MUX) 242 coupled to second processor 220 and super I/O 240.

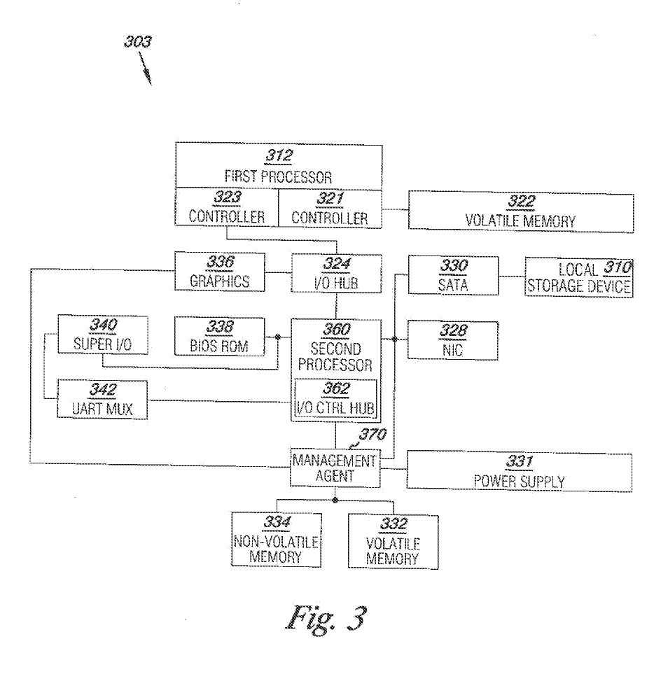

FIG. 3 illustrates a block diagram of a computing device 303 in accordance with an example of the present disclosure. Computing device 303 can be, for example, a server, among other types of computing devices.

As shown in FIG. 3, computing device 303 includes a local storage device 310. Local storage device 310 can be analogous to local storage device 110 previously described in connection with FIG. 1 and/or local storage device 210 previously described in connection with FIG. 2.

Computing device 303 also includes a first processor 312, as illustrated in FIG. 3. First processor 312 can be the main processor of computing device 303, in a manner analogous to first processor 112 previously described in connection with FIG. 1 and/or first processor 212 previously described in connection with FIG. 2. Additionally, first processor 312 can include controllers 321 and 323, as illustrated in FIG. 3. Controllers 321 and 323 can be analogous to controllers 221 and 223, respectively, previously described in connection with FIG. 2.

Computing device 303 also includes a second processor 360, as shown in FIG. 3. Second processor 360 can be an auxiliary processor, in a manner analogous to second processors 114 and 220 previously described in connection with FIGS. 1 and 2, respectively. Additionally, as illustrated in FIG. 3, second, e.g., auxiliary, processor 360 can include a component, e.g., I/O controller hub 362, to access a peripheral device. That is, second processor 360 can use I/O controller hub 362 to access a peripheral device, such as a computer monitor, printer, scanner, or speaker, among other types of peripheral devices,

Computing device 303 also includes a management agent 370 coupled to second processor 360, as shown in FIG. 3. That is, management agent 370 is separate, e,g., physically and/or operationally separate, from second processor 360, as illustrated in FIG. 3. Management agent 370 can be coupled to second processor 360 by, for example, a USB connection. Management agent 370 can also be coupled to a power supply 331, as shown in FIG. 3, by, for example, an I2C.

As shown in FIG. 3, computing device 303 also includes an I/O hub 324 coupled to controller 323 and second processor 360. I/O huh 324 can be analogous to I/O hub 224 previously described in connection with FIG. 2.

Computing device 303 also includes a NIC 328 and a SATA 330 coupled to second processor 360 and management agent 370, as illustrated in FIG. 3 NIC 328 and SATA 330 can be coupled to second processor 360 and management agent 370 by for example, a PCI. Local storage device 310 is coupled to SATA 330, as shown in FIG. 3.

Computing device 303 also includes a volatile memory 332 and a non-volatile memory 334 coupled to management agent 370, as shown in FIG. 3. Volatile memory 332 and non-volatile memory 334 can be analogous to volatile memory 232 and non-volatile memory 234, respectively, previously described in connection with FIG. 2.

First processor 312 can access local storage device 310 in a manner analogous to first processors 112 and/or 212 previously described in connection with FIGS. 1 and 2, respectively. Further, one of first processor 312 and second processor 360 can access local storage device 310 at a time, in a manner analogous to first processors 112 and/or 212 and, second, processors 114 and/or 220 previously described in connection with FIGS. 1 and 2, respectively.

Management agent 376 can shut down first processor 312 if a load associated with computing device 303 falls below a particular threshold and/or at a particular time of day, in a manner analogous to management agent 225 previously described in connection with FIG. 2. While first processor 312 is shut down, second processor 360 can access local storage device 310, in a manner analogous to second processors 114 and/or 220 previously described in connection with FIGS. 1 and 2, respectively.

Second processor 360 can use less power than first processor 312 while accessing local storage device 310. Hence, computing device 303 can use less power by switching to second processor 360, in a manner analogous to computing devices 100 and/or 202 previously described in connection with FIGS. 1 and 2, respectively.

Management agent 370 can shut down second processor 360 if the load associated with, computing device 303 exceeds a particular threshold while second processor 360 is accessing local storage device 310 and/or at a particular time of day, in a manner analogous to management agent 225 previously described in connection with FIG. 2. Upon shutting down second processor 360 management agent 370 can restart first processor 312, and then resume the accessing of local storage device 310 by first processor 312, in a manner analogous to management agent 225 previously described in connection with FIG. 2,

In a number of examples of the present disclosure, an additional computing device, e.g., an additional server, can access local storage device 310 via second processor 360. For example, second processor 360 can be coupled to the additional server by a small computer system interface (SCSI) connection, and second processor 360 can provide the additional server with remote direct memory access (RDMA) to local storage device 310 via the SCSI connection. In such examples, the additional server may include the operating system used by second processor 360 and/or the additional server to access local storage device 310.

As shown in FIG. 3, computing device 303 includes a volatile memory 322 coupled to first processor 312. Volatile memory 322 can be analogous to volatile memory 222 previously described in connection with FIG. 2. Data stored in volatile memory 322 can be transferred to local storage device 310 prior to shutting down first processor 312, in a manner analogous to that previously described in connection with FIG. 2.

Computing device 303 also includes a graphics module 336 coupled to management agent 370 and I/O hub 324, as illustrated in Figure Graphics module 336 can be coupled to management agent 370 by, for example, a digital video connection, and graphics module 336 can be coupled to I/O hub 324 by, for example, a pole connection.

As shown in FIG. 3, computing device 30, also includes a BIOS ROM 338 and a super I/O 340 coupled to second processor 360. BIOS ROM 338 and super I/O 340 can be coupled to second processor 360 by, for example an LPC bus connection. Computing device 303 also includes a UART MUX 342 coupled to second processor 360 and super I/O 340.

Although specific examples have been illustrated and described herein, those of ordinary skill in the art will appreciate that an arrangement calculated to achieve the same results can be substituted for the specific examples shown. This disclosure is intended to cover adaptations or variations of a number of examples of the present disclosure. It is to be understood that the above description has been made in an illustrative fashion, and not a restrictive one. Combination of the above examples, and other examples not specifically described herein will be apparent to those of skill in the art upon reviewing the above description. The scope of a number of examples of the present disclosure includes other applications in which the above structures and methods are used. Therefore, the scope of a number of examples of the present disclosure should be determined with reference to the appended claims, along with the full range of equivalents to which such claims are entitled.

In the foregoing Detailed Description, some features are grouped together in a single example for the purpose of streamlining the disclosure. This method of disclosure is not to be interpreted as reflecting an intention that the disclosed examples of the present disclosure have to use more features than are expressly recited in each claim. Rather, as the following claims reflect, inventive subject matter lies in less than all features of a single disclosed example. Thus, the following claims are hereby incorporated into the Detailed Description, with each claim standing on its own as a separate example.

What is claimed:

1. A computing device (100, 202, 303), comprising:
a local storage device (110, 210, 310):
a first processor (112, 212, 312) able to access the local storage device;
an auxiliary processor (114, 220, 360) able to access the local storage device (110, 210, 310) while the first processor (112, 212, 312) is shut down, wherein the auxiliary processor (114, 220, 360) uses less power than the first processor (112, 212, 312); and
a management agent (125, 225, 370) to initiate an accessing of the local storage device (110, 210, 310) by the auxiliary processor (114, 220, 360) if a load associated with the computing device (100, 202, 303) falls below a particular threshold, and
wherein one of the first processor (112, 212, 312) and the auxiliary processor (114, 220, 360) is able to access the local storage device (110, 210, 310) at a time.

2. The computing device (100, 202, 303) of claim 1, wherein the management agent (125, 225, 370) is able to shut down the first processor (112, 212, 312) if the load falls below the particular threshold.

3. The computing device (100, 202, 303) of claim 1, wherein the management agent (125, 225, 370) is able to initiate a power up of the auxiliary processor (114 220, 368) if the load falls below the particular threshold.

4. The computing device (100, 202) of claim 1, wherein the management agent (125, 225) is included in the auxiliary processor (114, 220)

5. The computing device (303) of claim 1, wherein the management agent (370) is separate from the auxiliary processor (360).

6. The computing device (100, 202) of claim 1, wherein the auxiliary processor (114, 220) includes a component (227) to access a network.

7. The computing device (100, 202, 303) of claim 1, wherein the local storage device (110, 210, 310) is a hard disk drive.

8. The computing device (100, 202, 303) of claim 1, wherein the auxiliary processor (114, 220, 360) includes fewer caches and fewer buffers than the first processor (112, 212, 312).

9. The computing device (100, 202, 303) of claim 1, wherein:
the first processor (112, 212, 312) accesses the local storage device (110, 210, 310) using an operating system; and
the auxiliary processor (114, 220, 360) accesses the local storage device (110, 210, 310) using the operating system.

10. The computing device (100, 202, 303) of claim 1, wherein:
the first processor (112, 212, 312) accesses the local storage device (110, 210, 310) using a first operating system; and
the auxiliary processor (114, 220, 360) accesses the local storage device (110, 210, 310) using a second operating system that is different than the first operating system.

11. A method of operating a computing device (100, 202, 303), comprising:
shutting down a first processor (112, 212, 312) having access to a local storage device (110, 210, 310) if a load associated with the computing device (100, 202, 303) falls below a particular threshold; and
powering up an auxiliary processor (114, 220, 360) having access to the local storage device (110, 210, 310) upon the shut down of the first processor (112, 212, 312);
wherein the auxiliary processor (114, 220, 360) uses less power than the first processor (112, 212, 312).

12. The method of claim 11, wherein the method includes:
shutting down the auxiliary processor (114, 220, 360) if the load associated with the computing device (100, 202, 303) exceeds a particular threshold; and
restarting the first processor (112, 212, 312) upon the shut down of the auxiliary processor (114, 220, 360).

13. The method of claim 12, wherein the method includes:
shutting down the first processor (112, 212, 312) and powering up the auxiliary processor (114, 220, 360) at a first time of day; and
shutting down the auxiliary processor (114, 220, 360) and restarting the first processor (112, 212, 312) at a second time of day,

14. The method of claim 11, wherein the method includes transferring data from a memory (222, 322) associated with the first processor (212, 312) to the local storage device (210, 310) prior to shutting down the first processor (212, 312).

15. A non-transitory computer readable medium (232, 234, 332, 334) having computer readable instructions stored thereon that are executable by a processor (220, 360) to:
shut down a first processor (112, 212, 312) having access to a local storage device (110, 210, 310) if a utilization of the first processor (112, 212, 312) falls below a particular threshold;
initiate an accessing of the local storage device (110, 210, 310) by an auxiliary processor (114, 220 360) after the first processor (112, 212, 312) is shut down;
shut down the auxiliary processor (114, 220, 360) if a utilization of the auxiliary processor (114, 220, 360) exceeds a particular threshold; and
restart the first processor (112, 212, 312) after the auxiliary processor is shut down (114, 220, 360).
